(19) United States
(12) Patent Application Publication
(10) Pub. No.: US 2015/0154519 A1
(43) Pub. Date: Jun. 4, 2015

(54) ANALYZING INCOMPLETE TRANSACTIONS

(71) Applicant: Gavin Doolan, Dublin (IE)

(72) Inventor: Gavin Doolan, Dublin (IE)

(21) Appl. No.: 13/663,843

(22) Filed: Oct. 30, 2012

(51) Int. Cl. G06Q 30/00; G06Q 10/06; G06Q 30/06

(52) U.S. Cl. CPC G06Q 10/063; G06Q 30/0633

(57) ABSTRACT

Analyzing incomplete transactions may be used to improve an online retailer's ability to market and sell items, such as products and/or services. A transaction may begin by a user selecting an item to be added to a virtual shopping cart. Data related to the item and the pending transaction may be stored in a data structure. If a transaction is not completed, the data may be used to determine a context of for the incomplete transaction. Based on the context, a report may be generated. In some instances, a feedback feature, such as a pop-up window, may be provided to the user if the user removes the item from the shopping cart.

### BACKGROUND

Virtual shopping carts may be a useful way for users to select and review items, such as products and/or services, from an online retailer prior to completing an online purchase transaction. The virtual shopping cart process typically takes several steps, such as selecting an item from a list of items available for purchase from a resource of an online retailer, reviewing the selected item, and providing or selecting payment and/or shipping information to complete the online purchase transaction. In some instances, an online purchase transaction may not be completed by a user after having placed a retailer's item into the virtual shopping cart.

### SUMMARY

In one implementation, a method for analyzing incomplete transactions may include receiving data indicative of a selection of an item to be added to a virtual shopping cart. Data for an identifier of the item to be added to the shopping cart may be stored in a data structure. A determination may be made that the transaction for the item was not completed. A context for the incomplete transaction may be determined, including a stage at which the transaction was not completed. A report may be generated based on the determined context for the incomplete transaction.

In another implementation, a system for analyzing incomplete transactions may include one or more data processors and one or more storage devices storing instructions to cause the one or more data processors to perform various operations. The operations may include receiving data indicative of a selection of an item to be added to a virtual shopping cart from a user device associated with a device identifier. Data, including an item identifier for the item added to the virtual shopping cart, may be stored in a data structure. A determination may be made that the transaction for the item was not completed. The determination may include determining that the item was removed from the virtual shopping cart, determining that the user selected a cancellation button, or determining that a predetermined time period has elapsed without a completed transaction for the item. A context for the incomplete transaction may be determined, and a report may be generated based on the determined context.

In still a further implementation, a computer readable storage device may store instructions to cause the one or more data processors to perform various operations. The operations may include receiving data for a selection of an item to be added to a virtual shopping cart from a user device associated with a device identifier. Data, including an item identifier for the item and the device identifier, may be stored in a data structure. A determination may be made that the transaction for the item was not completed. The determination may include determining that the item was removed from the virtual shopping cart, determining that the user selected a cancellation button, or determining that a predetermined time period has elapsed without a completed transaction for the item. A context, including a stage at which the transaction was not completed and one or more identifiers for other items added to the virtual shopping cart, for the incomplete transaction may be determined. A report may be generated based on the determined context for the transaction and several other transactions for the item and may include a determined incomplete transaction rate for the item for each stage of a plurality of stages of a transaction process.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of an example environment to access retail resources;

FIG. 2 is a flow diagram of an example process for analyzing incomplete transactions;

FIG. 3 is a block diagram of a data structure for storing data about one or more incomplete transactions;

FIG. 4 is an illustration of an example informational pop-up window that may be displayed in response to a determination of an incomplete transaction;

FIG. 5 is an illustration of an example feedback pop-up window that may be displayed in response to a determination of an incomplete transaction;

FIG. 6 is an illustration of an example e-mail that may be transmitted to obtain feedback data in response to a determination of an incomplete transaction;

FIG. 7 is a flow diagram of an example process for obtaining, analyzing and reporting incomplete transactions; and

FIG. 8 is a block diagram illustrating an architecture for a computer system that may be employed to implement various elements of the systems and methods.

Like reference numbers and designations in the various drawings indicate like elements.

### DETAILED DESCRIPTION

One or more implementations provide for obtaining data regarding incomplete purchase transactions for retail resources that result in shopping cart abandonment. The data can be obtained directly from the user, such as by way of an e-mail or a feedback pop-up window to explain why the user did not complete the purchase, or by obtaining data as to which items, such as products and/or services, offered for purchase by a retailer resulted in shopping cart abandonment. One or more implementations may reduce the probability of shopping cart abandonments, which may be beneficial to the retailer.

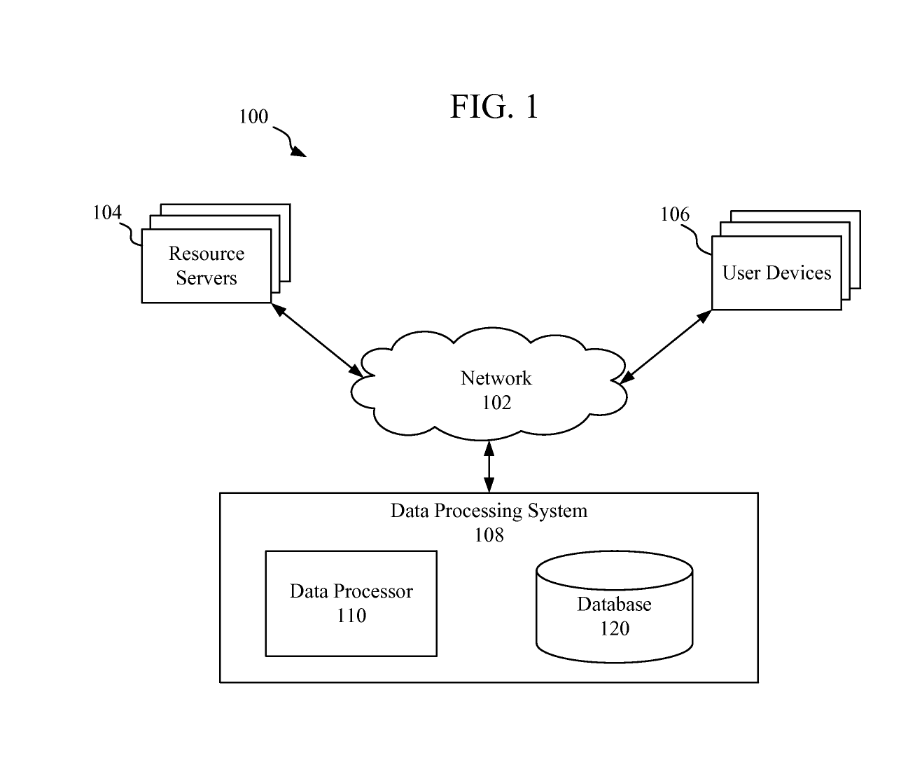

FIG. 1 illustrates an example system 100 for providing information via at least one computer network such as the network 102. The network 102 can include computer networks such as the Internet, local, wide, metro or other area networks, intranets, and other computer networks such as voice or data mobile phone communication networks. The system 100 can also include at least one data processing system 108. The data processing system 108 can include at least one logic device such as a computing device having a processor to communicate via the network 102, for example with at least one resource server 104 and at least one user device 106. The data processing system 108 can include one or more data processors 110 configured to process data and provide data to the resource server 104 and/or the user device 106, and one or more databases 120 configured to store data. The data processing system 110 may include at least one server, such as an advertisement server, content server, or any other server.

Each resource server 104 may transmit data for one or more resources associated with a domain name and hosted by the resource server 104. The resources may include any data that can be provided over the network 102. The resources can include web pages, word processing documents, portable document format (PDF) documents, images, video, programming elements, interactive content, and feed sources, to name only a few. An example resource may include a collection of web pages formatted in hypertext markup language (HTML) that can contain text, images, multimedia content, and/or programming elements, such as scripts. The resources can include content, such as words, phrases, images and sounds, that may include embedded information (such as meta-information in hyperlinks) and/or embedded instructions. Embedded instructions can include code that is executed at a user's device, such as in a web browser. Code can be written in languages, such as, JavaScript® or ECMAScript®. The resource may be designated by a resource address that is associated with the resource server 104, such as a URL.

A user device 106 may be an electronic device that is under the control of a user. The user device 106 is configured to request and receive resources over the network 102. Example user devices 106 include personal computers, mobile communication devices (e.g., cellular telephone, smart phone, etc.), and other computing devices (e.g., having a processor and memory or other type of computer-readable medium) that can send and receive data over the network 102. In some implementations, the user devices 106 may include an application, such as a web browser, to facilitate the sending and receiving of data over the network 102. In other implementations, the user devices 106 may include an application (e.g., phone application) for communication with online systems. The user devices 106 can request resource data from a resource server 104 such that the user device 106 may effect display of the resource on a display device of the user device 106 or otherwise (e.g., on an electronic display, as an audible sound via a speaker, or a combination thereof).

One or more processors of the user device 106 may be in communication with a display and may execute a software application, such as a web browser, on the user device 106. The web browser may operate by receiving input of a resource name or network address into a field, such as a web address field, from an input device (e.g., a pointing device, a keyboard, a touchscreen, etc.). In response, the one or more processors of the user device 106 may cause a request to be sent to a resource server 104 for resource data associated with the requested resource over a network (e.g., the Internet, an intranet, etc.) to the resource server 104 associated with the resource name and/or network address. The resource server 104 may provide resource data, such as web page data, to the user device 106 responsive to the request, which may cause visual indicia for the resource to be displayed to the user on a display of the user device 106.

In some instances, the resource servers 104 may include one or more retail resources that offer items, such as products and/or services, for purchase. In some instances, users may select items for purchase over the Internet by selecting the item for inclusion in a representation of a shopping cart associated with a retail resource. For example, selection of an item may cause data to be added to a data file, such as a cookie, stored on the user device 106 to indicate that the item was added to the representation of the shopping cart. A user may complete a purchase procedure by providing payment information to complete the transaction during a payment process.

For situations in which the systems discussed here collect information about users, or may make use of information about users, the users may be provided with an opportunity to control whether programs or features that may collect user information (e.g., information about a user's social network, social actions or activities, a user's preferences, or a user's current location), or to control whether and/or how to receive content from the content server that may be more relevant to the user. In addition, certain data may be treated in one or more ways before it is stored or used, so that certain information about the user is removed when generating parameters (e.g., demographic parameters). For example, a user's identity may be treated so that no identifying information can be determined for the user, or a user's geographic location may be generalized where location information is obtained (such as to a city, ZIP code, or state level), so that a particular location of a user cannot be determined. Thus, users may have control over how information is collected about them and used by a content server.

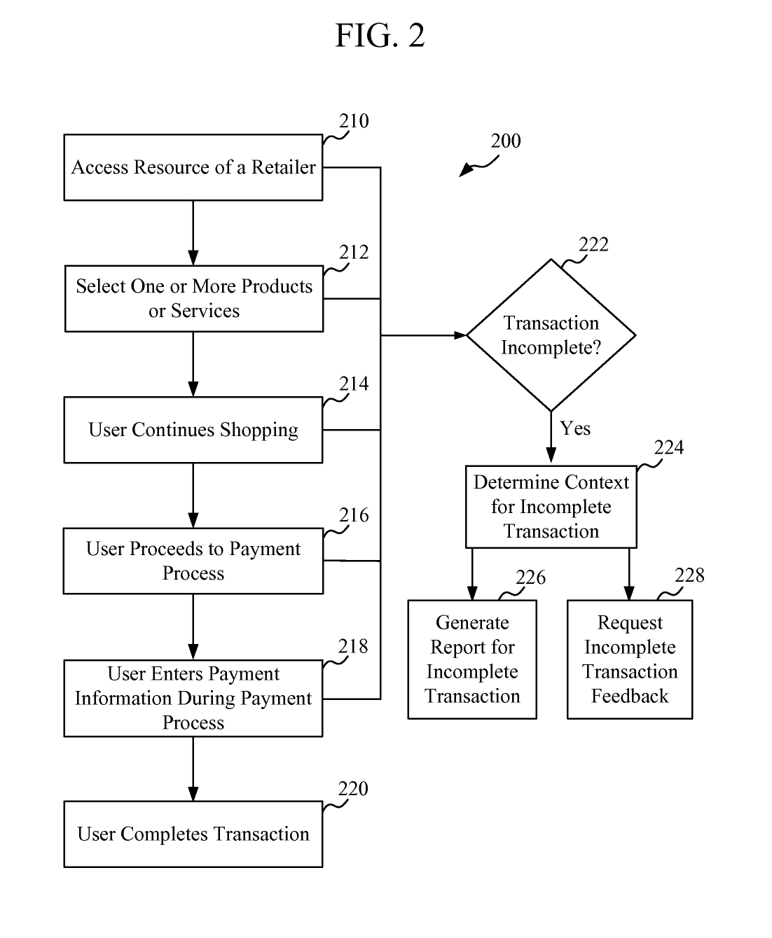

FIG. 2 depicts a flow diagram of an example method 200. A user, such as a consumer, may access a resource of an online retailer (step 210). Such access may include requesting resource data from a resource server, receiving the resource data, and effecting display of the resource on a display of the user device based on the resource data received from the resource server. In some implementations, the resource may include one or more items displayed to the user for selection for purchase.

The user may select one or more items of the displayed resource of the online retailer (step 212). In some instances, this may include by adding the one or more items to a virtual shopping cart associated with the resource. Adding the items to the shopping cart may include causing data to be added to a data file, such as a cookie, stored on the user device to indicate that the item was added to the shopping cart. In some other implementations, the user device may transmit data to the retail resource server to associate the selected items with a shopping cart associated with a device identifier of the user device. In some instances, when the user selects the item to be added to the shopping cart, a request to the resource server for resource data for a shopping cart web page may be transmitted from the user device. The resource server may transmit resource data to the user device to effect display of a shopping cart web page and/or frame that displays the selected item as part of the virtual shopping cart and may provide the user with buttons or other features to proceed to a payment or checkout process or to continue shopping.

The user may elect to temporarily leave the shopping cart web page to select more items for purchase and/or may otherwise continue selecting items to be added to the virtual shopping cart (step 214). For example, the user may select a “return to shopping” button or link displayed with the shopping cart web page. When the consumer has finished selecting items for purchase, the user may proceed to a payment process (step 216). For instance, the user may select a “checkout” or “payment” button or link displayed on the same display that shows the shopping cart web page. In some instances, the user may proceed to the payment process after selecting a single item or may proceed to the payment process after multiple items have been selected for inclusion in the shopping cart.

During the payment process, the user may enter information regarding a payment method for purchasing the items placed in the shopping cart, such as payment by credit card, debit card, or the like (step 218). In some implementations, the payment process may include multiple stages, such as a payment information stage, shipping information stage, confirmation stage, etc. Each stage may be presented to the user by a separate resource, such as a web page, during the payment process. Until the user has confirmed or otherwise completed the payment process, the user may cancel or abandon the transaction without purchasing the items. For instance, the user may select a “cancel” button displayed to the user with the shopping cart web page and/or any of the web pages displayed during the payment process. In other instances, the user may navigate away from the resource of the retailer and/or close the browser window displaying the resource.

In some instances, the user may complete the transaction (step 220) by completing the payment process and/or otherwise. In other instances, a determination that the transaction was not completed may be made (step 222). The determination that the transaction was incomplete will be described in greater detail below. Such a determination may occur during any of the previous steps 210, 212, 214, 216, 218. The determination that the transaction was incomplete may result from user input, such as by a user selecting a cancellation button and/or removing an item from the shopping cart, or may occur passively, such as by a predetermined time lapsing (e.g., 10 minutes without a user completing the transaction) or by the user navigating away from the resource of the retailer. In still other instances, a user may remove an item from the virtual shopping cart (e.g., by selecting a delete button, link, icon, or the like). Thus, removal of the item may also be considered an incomplete transaction for the individual product even if the user ultimately completes a transaction for other items.

If a determination is made that the transaction was incomplete (step 222), a determination of the context for the incomplete transaction may be made (step 224) to obtain data about the incomplete transaction with the retailer. As noted above, a device identifier may be associated with a user device of the user, such as a cookie, when the user device requests the resource data for the resource of the retailer. For situations in which the systems discussed here collect information about users, or may make use of information about users, the users may be provided with an opportunity to control whether programs or features that may collect user information (e.g., information about a user's social network, social actions or activities, a user's preferences, a user's e-mail, or a user's current location), or to control whether and/or how to receive content from the content server that may be more relevant to the user. In addition, certain data may be treated in one or more ways before it is stored or used, so that certain information about the user is removed when generating parameters (e.g., demographic parameters). For example, a user's identity may be treated so that no identifying information can be determined for the user, or a user's geographic location may be generalized where location information is obtained (such as to a city, ZIP code, or state level), so that a particular location of a user cannot be determined. Thus, users may have control over how information is collected about them and used.

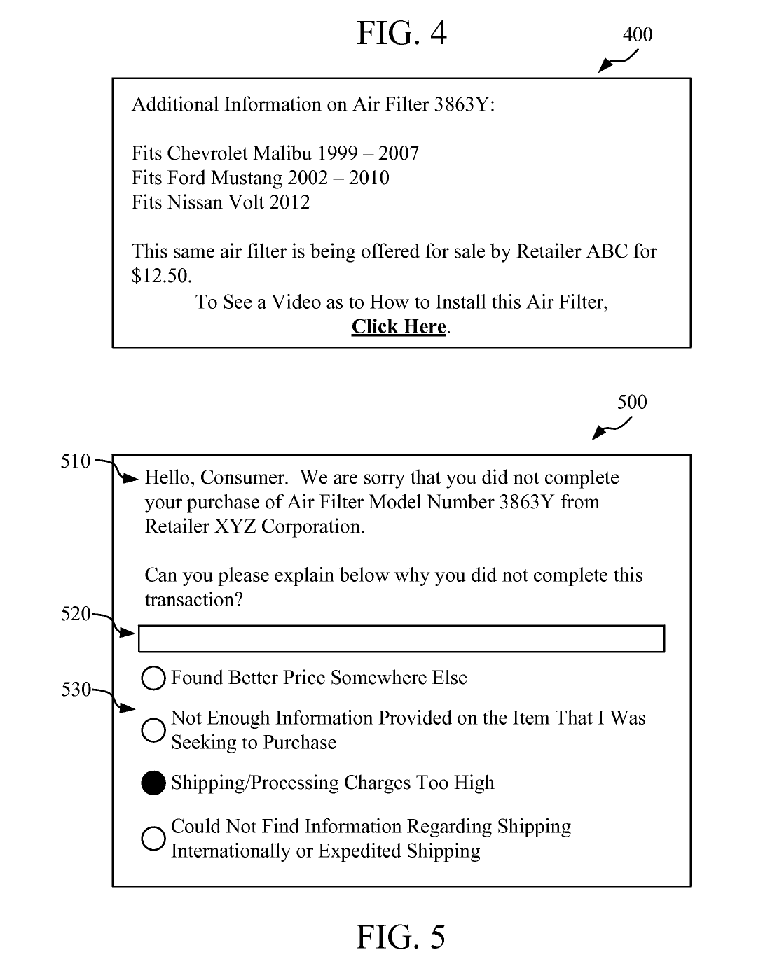

In some implementations, when an incomplete transaction is determined (step 222), the data file, such as a cookie, stored on the user device to indicate that the item was added to the shopping cart may be transmitted back to the resource server and/or to a data processing system. In some instances, the data file may include data about the context of the incomplete transaction. For example, the data file may include a variable that modified as the user device proceeds through the transaction process (e.g., transaction=x, where the value of x may be a number such that 0=no items in the shopping cart; 1=item in shopping cart; 2=entering payment information; 3=entering shipping information; 4=confirmation page; 5=completed transaction, etc.). Thus, depending on the value for the variable, a determination may be made as to what part of the transaction the user had progressed before the transaction ended or was abandoned. In some instances, when an incomplete transaction is determined, such as when an item is removed from the virtual shopping cart or when a predetermined amount of time has passed without a completed transaction, a pop-up window or other informational feature, such as that shown and described in reference to FIG. 4, may be displayed on a display of a user device to provide additional information about the item. Such additional information may reassure the user about the item in order to further advance the transaction toward completion.

In some implementations, the context may include data concerning the other items selected for inclusion in the virtual shopping cart; whether the other items were removed, were also the subject of an incomplete transaction, and/or had their transaction completed; what items were viewed; time spent looking at each item; and/or other contextual information. In some implementations, any of the foregoing data may be maintained on the resource server and/or data processing system such that no data file may be stored on the user device.

The determined contextual data may be used to generate a report (step 226) and/or to request incomplete transaction feedback from the user (step 228). For example, if the retailer is an automotive parts retailer, an item for purchase may be a specific air filter. The contextual data determined from step 224, in addition to contextual data from other transactions, may be used to determine an incomplete transaction rate. For example, the report may indicate that 75% of all transactions involving the specific air filter result in incomplete purchases. Such data may be used to generate a report for the retailer such that the retailer may adjust one or more aspects of how they attempt to sell the specific air filter. In some instances, the contextual data for the report may be further broken down to provide additional insight to the retailer. For example, the incomplete transactions may be sub-divided based on the part of the transaction process at which the transaction was abandoned. For example, 7% of the transaction having the specific air filter in a virtual shopping cart never proceed to the payment process; 3% of the transactions have the air filter removed from the shopping cart; 12% of the transactions end at a payment web page; 38% of the transactions end at a shipping page; and 40% of the transactions end at the confirmation page. Such information may be provided via the generated report to the retailer.

In another example, the generated report may include statistics on what other items were selected for inclusion in the shopping cart with a particular item. For instance, using the previous example, a generated report may indicate that a significant percentage of incomplete transactions for a specific air filter may also include an oil filter in the shopping cart as well. Thus, a retailer may decide to offer a discount for purchasing the air filter with an oil filter to improve the likelihood that the air filter transactions may be completed. In some instances, the report may include other items the user device requested to view such that the retailer may use the data to improve completed transactions for the specific air filter. In still further instances, the report may include data on the time a user device spends viewing an item before requesting a different resource, such as a web page for another item, such that the retailer may use the data to improve completed transactions, such as by providing additional information about the viewed item. Of course still other data may be included in the generated report.

The retailer may use the report to modify how the items are displayed, marketed, etc. For example, the retailer may provide additional information about the item, position the display of the item in a different position on the displayed resource, change the pricing of the item, offer a discount or other incentive for the item, etc. The generated report may be output daily, weekly, monthly, and/or on demand.

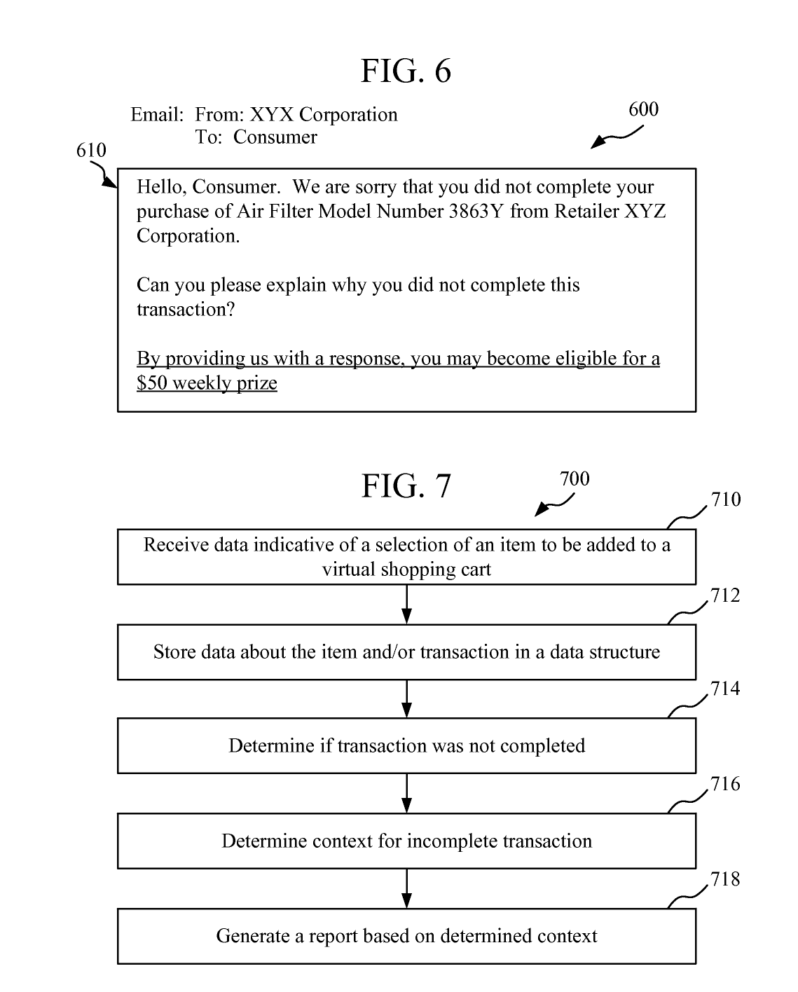

In some instances, a request for incomplete transaction feedback may be made (step 228). For example, a pop-up window may be displayed to request feedback from the user regarding the incomplete transaction. An example of such a pop-up window is shown and described in reference to FIG. 5. Feedback may also be requested via an e-mail, such as that shown and described in reference to FIG. 6, or other communicative format.

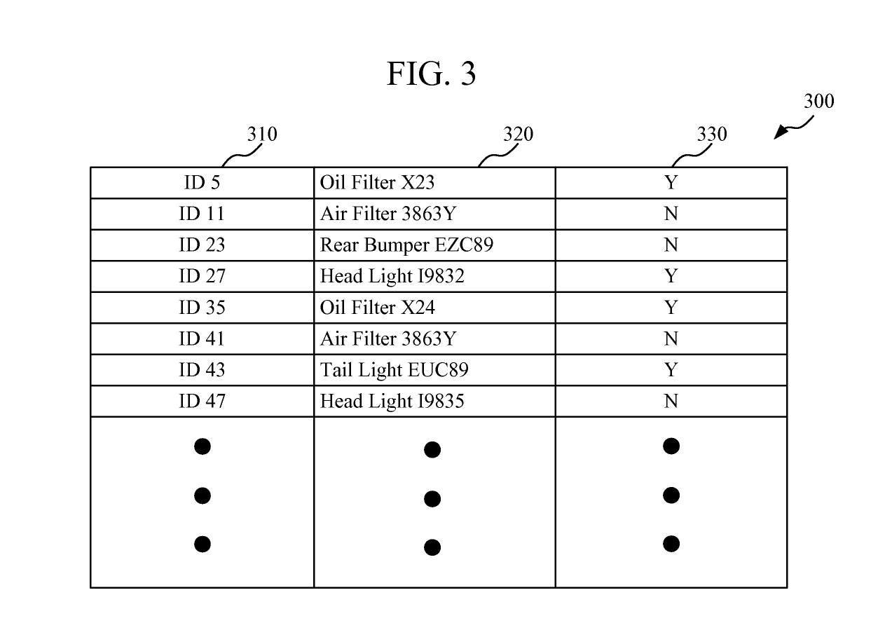

FIG. 3 shows an example block diagram of a data structure 300 that stores data indicative of one or more transactions, including data indicative of whether the transaction was completed. In the present example, data structure 300 may include a first field data 310 for an ID for the device identifier for a user device, a second data field 320 for an identifier for the item, and a third data field 330 for an indicator of the transaction status. For example, a “Y” in the third data field 330 may be indicative of a completed transaction and an “N” may be indicative of an incomplete transaction. Still other data fields may be used as well, such as a data field for one or more indicators for one or more viewed other items, a data field for one or more indicators for one or more other items also selected for inclusion in the shopping cart, a data field for one or more indicators for a time value for viewing an item, a data field for one or more indicators indicative of the stage of the transaction when the transaction ended, and/or other data fields. In some instances, the data structure 300 may be for a single item or may be for multiple items. In addition, as noted above, such a data structure may be local to a user device, such as a cookie stored on the user device, or may be on a resource server or data processing system.

FIG. 4 shows an illustrative informational pop-up window 400 that may be provided in some implementations. In some instances, pop-up window 400 may be provided in response to an item being removed from the virtual shopping cart or in response to a predetermined amount of time having passed without a completed transaction. In another implementation, pop-up window 400 may be configured to display if the product and/or service was determined to be more likely than other items to result in an incomplete transaction. Pop-up window 400 of such an example may include information for the types of vehicles that the air filter fits in, prices for the air filter of other retailers, and/or other information about the air filter. Such additional information may cause a user to be more likely to complete the transaction.

FIG. 5 depicts an example feedback pop-up window 500. For example, when a user fails to complete a transaction (i.e., the user placed an item in a shopping cart, but failed to complete the payment process and/or otherwise), then the user may be provided with an opportunity to provide feedback to the retailer to explain why the transaction was not completed. Feedback pop-up window 500 may include a first section 510 to provide a greeting to the consumer and reference the item that was the subject of the incomplete transaction. For example, “Hello, NAME. We are sorry that you did not complete your purchase of ITEM from Company X. Can you please explain why you did not complete that transaction?” may be provided in first section 510. The user may decide to provide responsive information in a text entry region 520 of the pop-up window 500. Text entry region 520 may allow for the user to provide a reason why the purchase transaction was not completed. In some instances, pre-populated reasons 530 may be provided such that the user may select a reason, such as “found a better price somewhere else,” “not enough information on the product to feel comfortable with the purchase,” “shipping and processing charges too high,” and/or “could not find information regarding shipping internationally or expedited shipping.” These reasons may be provided with a proximate selection feature, such as a radio button, check box, etc., such that the user may select or otherwise indicate one or more of the reasons.

In some other implementations, instead of providing the user with a feedback pop-up window for providing feedback, such as that shown in FIG. 5, an e-mail, such as e-mail 600 shown in FIG. 6, may be transmitted to the consumer in response to the incomplete transaction. In some implementations, the e-mail address may be obtained from registration information provided by the user, from a prior site visit by a previously registered user that has logged in during the current session, and/or from a pop-up window or other feature for the user to enter an e-mail address. The user may respond to the e-mail by explaining why the transaction was not completed. As an incentive to respond to the e-mail, the user may be provided with a discount incentive or other purchase incentive on a next purchase with the retailer, the user may be entered into a sweepstakes, and/or otherwise.

FIG. 7 depicts an example method 700 for analyzing incomplete transactions. A user of a user device may request resource data for a resource, such as a retailer's web site. The resource data may be transmitted to the user device to effect display of the resource on a display of the user device. The user may select an item to be added to a virtual shopping cart, such as through a selection button (e.g., “Add to Cart,” etc.). In response, data indicative of the selection of the item being added to the virtual shopping cart may be received (step 710). In some instances, the data may be transmitted to the resource server and/or to a data processing system remote from the user device. In other implementations, the data may be received at the user device.

In response to receiving data indicative of a selection of an item to be added to a shopping cart, data about the item and/or transaction may be stored in a data structure (step 712). For example, the data may include an item identifier associated with the item selected to be added to the shopping cart. In some implementations, a device identifier may also be stored and associated with the item identifier. In some other implementations, data indicative of a stage of the transaction may be stored. In still further examples, data indicative of other items added to the virtual shopping cart; data indicative of whether the other items were removed; data indicative of whether the other items were also the subject of an incomplete transaction or completed transaction; data indicative of what items were viewed; data indicative of how much time spent a user spent looking at each item; and/or other data may be stored as well.

A determination may be made as to whether the transaction was completed (step 714). In some instances, the determination may be made based on data indicative that the user removed the item from the virtual shopping cart, such as by selecting a remove button or other feature. In some other instances, the determination may be made based on the user selecting a cancellation button or other feature to end the transaction. For example, during a shipping information stage, the user may decide to cancel the transaction and selects a “Cancel” button. In still other instances, the determination may be made based on a predetermined time period elapsing without a completed transaction. For example, the predetermined time period may be 2, 5, 10, 20, 30, or 60 minutes. If the transaction is not completed within the predetermined time period, the transaction may be considered incomplete. For instance, a user may simply navigate away from the retailer's web site without completing the transaction. Of course other ways of determining whether a transaction was not completed may be used as well.

A determination of the context for the incomplete transaction may be made (step 716). The context may include the stage at which the transaction ended, whether the user removed the item from the shopping cart, whether the user canceled the transaction, whether and what other items were selected for the virtual shopping cart, whether the other items were removed, whether the other items were also the subject of an incomplete transaction or completed transaction, what items were viewed, the time spent looking at each item, and/or other contextual information.

Based on the contextual information, a report may be generated based on the determined context (step 718). The report may be based on a single incomplete transaction, several incomplete transactions, and/or all incomplete and complete transaction. The contextual information may be used to determine an incomplete transaction rate for the item, overall and/or for various stages of the transaction. In another example, the generated report may include statistics on what other items were selected for inclusion in the shopping cart with a particular item. In other instances, the report may include other items the user device requested to view such that the retailer may use the data to improve completed transactions for the specific air filter. In still further instances, the report may include data on the time a user device spends viewing an item before requesting a different resource, such as a web page for another item. Of course still other data may be included in the generated report.

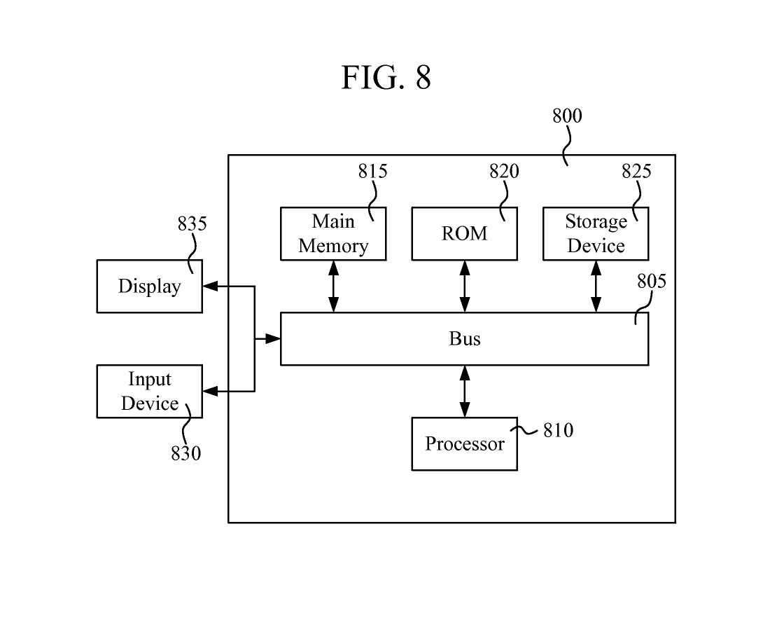

FIG. 8 shows the general architecture of an illustrative computer system 800 that may be employed to implement any of the methods or systems discussed herein in accordance with some embodiments. The computer system 800 can be used to provide information via the network 102. The computer system 800 comprises one or more processors 810 communicatively coupled to one or more computer-readable storage devices, such as main memory 815, ROM 820, and/or storage device 825, one or more buses 805, one or more output devices 835 (e.g., one or more display units), and/or one or more input devices 830. The computer system or computing device 800 may be used to implement the user devices 106, the resource servers 104, data processing system 108, etc. The computing system 800 may include main memory 815, such as a random access memory (RAM) or other dynamic storage devices, coupled to the bus 805 for storing information and/or instructions to be executed by the processor 810. Main memory 815 can also be used for storing position information, temporary variables, or other intermediate information during execution of instructions by the processor 810. The computing system 800 may also include a read only memory (ROM) 810 or other static storage devices coupled to the bus 805 for storing static information and instructions for the processor 810. Storage device 825, such as a solid state device, magnetic disk or optical disk, may also be coupled to the bus 805 for persistently storing information and instructions.

The computing system 800 may be coupled via the bus 805 to a display 835, such as a liquid crystal display, or active matrix display, for displaying information to a user. An input device 830, such as a keyboard including alphanumeric and other keys, may be coupled to the bus 805 for communicating information and command selections to the processor 810. In another implementation, the input device 830 may include a touch screen display. The input device 830 can include a cursor control, such as a mouse, a trackball, or cursor direction keys, for communicating direction information and command selections to the processor 810 and for controlling cursor movement on the display 835.

According to various implementations, the processes described herein can be implemented by the computing system 800 in response to the processor 810 executing an arrangement of instructions contained in main memory 815. Such instructions can be read into main memory 815 from another computer-readable storage device, such as the storage device 825. Execution of the arrangement of instructions contained in main memory 815 causes the computing system 800 to perform the illustrative processes described herein. One or more processors in a multi-processing arrangement may also be employed to execute the instructions contained in main memory 815. In alternative implementations, hard-wired circuitry may be used in place of or in combination with software instructions to effect illustrative implementations. Thus, implementations are not limited to any specific combination of hardware circuitry and software.

Although an example computing system has been described in FIG. 8, implementations of the subject matter and the functional operations described in this specification can be implemented in other types of digital electronic circuitry, or in computer software embodied on a tangible medium, firmware, or hardware, including the structures disclosed in this specification and their structural equivalents, or in combinations of one or more of them.

Embodiments of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The features disclosed herein may be implemented on a smart television module (or connected television module, hybrid television module, etc.), which may include a processing module configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a Smartphone, other mobile phone, handheld computer, a tablet PC, or other computing device.

The operations described in this specification can be performed by a data processing apparatus on data stored on one or more computer-readable storage devices or received from other sources.

The term “data processing apparatus” or “computing device” or “processing circuit” encompasses all kinds of apparatus, devices, and machines for processing data, including by way of example a programmable processor, a computer, a system on a chip, or multiple ones, a portion of a programmed processor, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate embodiments consisting of the items listed thereafter exclusively. In one embodiment, the systems and methods described herein consist of one, each combination of more than one, or all of the described elements, acts, or components.

Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements to single or plural configurations. References to any act or element being based on any information, act or element may include embodiments where the act or element is based at least in part on any information, act, or element.

Any implementation disclosed herein may be combined with any other implementation or embodiment, and references to “an implementation,” “some implementation,” “an alternate implementation,” “various implementation,” “one implementation” or the like are not necessarily mutually exclusive and are intended to indicate that a particular feature, structure, or characteristic described in connection with the embodiment may be included in at least one implementation or embodiment. Such terms as used herein are not necessarily all referring to the same embodiment. Any embodiment may be combined with any other embodiment, inclusively or exclusively, in any manner consistent with the aspects and embodiments disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing embodiments are illustrative rather than limiting of the described systems and methods. Scope of the systems and methods described herein is thus indicated by the appended claims, rather than the foregoing description, and changes that come within the meaning and range of equivalency of the claims are embraced therein.

1. A method of analyzing incomplete transactions, comprising:
receiving, by one or more data processors, data indicative of a selection of an item to be added to a virtual shopping cart;
storing, in a data structure, data comprising an identifier for the item added to the virtual shopping cart;
determining, by one or more data processors, that a transaction for the item was not completed;
determining, by one or more data processors, a context for the transaction that was not completed, the context comprising a stage at which the transaction was not completed and data about an additional item of the virtual shopping cart, the data about the additional item comprises one of an indicator of removal of the additional item, an indicator of an abandonment of the additional item, an indicator of a completed transaction for the additional item, or an indicator for a time value indicative of a viewing time for the additional item;
determining, by one or more data processors, a first incomplete transaction rate for the item for each of a plurality of stages of a transaction process and a second incomplete transaction rate for the item based on the data about the additional item; and
generating, by one or more data processors, a report based on the determined context for the transaction that was not completed, the report comprising the first incomplete transaction rate for the item for each of the plurality of stages of the transaction process and the second incomplete transaction rate for the item based on the data about the additional item.

2. The method of claim 1, wherein the determination that the transaction for the item was not completed comprises at least one of:
determining, by one or more processors, that the user selected a cancellation button, and
determining, by one or more processors, that a predetermined time period has elapsed without a completed transaction for the item.

3.-6. (canceled)

7. The method of claim 1, wherein the data about the additional item comprises the indicator for the time value indicative of the viewing time for the additional item.

8. The method of claim 1, wherein the data about the additional item comprises the indicator of removal of the additional item from the virtual shopping cart.

9. The method of claim 8 further comprising:
transmitting display data to effect display of a feedback feature on a display of a user device responsive to the determined context comprising the indicator of removal of the additional item from the virtual shopping cart.

10. The method of claim 9, wherein the feedback feature comprises a text entry region.

11. The method of claim 9, wherein the feedback feature comprises one or more pre-populated feedback reasons.

12. The method of claim 1, further comprising:
transmitting a feedback e-mail in response to the determination that the transaction for the item was not completed.

13. A system for analyzing incomplete transactions, comprising:
one or more data processors; and
one or more storage devices storing instructions that, when executed by the one or more data processors, cause the one or more data processors to perform operations comprising:
receiving data indicative of a selection of an item to be added to a virtual shopping cart from a user device associated with a device identifier;
storing, in a data structure, data comprising an item identifier for the item added to the virtual shopping cart and the device identifier;
determining that a transaction for the item was not completed, wherein the determination that the transaction was not completed comprises at least one of:
determining that the user selected a cancellation button, or
determining that a predetermined time period has elapsed without a completed transaction for the item;
determining a context for the transaction that was not completed, the context comprising data about an additional item of the virtual shopping cart, the data about the additional item comprises one of an indicator of removal of the additional item, an indicator of an abandonment of the additional item, an indicator of a completed transaction for the additional item, or an indicator for a time value indicative of a viewing time for the additional item;
determining a first incomplete transaction rate for the item and a second incomplete transaction rate for the item based on the data about the additional item; and
generating a report based on the determined context for the transaction that was not completed, the report comprising the first incomplete transaction rate for the item and the second incomplete transaction rate for the item based on the data about the additional item.

14. (canceled)

15. The system of claim 13, wherein the context comprises a stage at which the transaction was not completed and an identifier for the additional item added to the virtual shopping cart.

16. The system of claim 15, wherein the data about the additional item comprises the indicator of removal of the additional item-from the virtual shopping cart, wherein the instructions further cause the one or more data processors to perform operations comprising:
transmitting display data to effect display of a feedback feature on a display of the user device responsive to the determined context comprising the indicator of removal of the additional item from the virtual shopping cart.

17. The system of claim 13, wherein the instructions further cause the one or more data processors to perform operations comprising:
transmitting a feedback e-mail in response to the determination that the transaction for the item was not completed.

18. A non-transitory computer readable storage device storing instructions that, when executed by one or more data processors, cause the one or more data processors to perform operations comprising:
receiving data indicative of a selection of an item to be added to a virtual shopping cart from a user device associated with a device identifier;
storing, in a data structure, data comprising an item identifier for the item and the device identifier;
determining that a transaction for the item was not completed, wherein the determination that the transaction was not completed comprises at least one of:
determining that the user selected a cancellation button, or
determining that a predetermined time period has elapsed without a completed transaction for the item;
determining a context for the transaction that was not completed, the context comprising a stage at which the transaction was not completed and a second item identifier for a second item added to the virtual shopping cart;
determining an overall incomplete transaction rate for the item, a first incomplete transaction rate for the item at each of a plurality of stages of a transaction process, and a second incomplete transaction rate for the item with the second item added to the virtual shopping cart for each of the plurality of stages of the transaction process; and
generating a report based on the determined context for the transaction that was not completed and a plurality of other transactions for the item, the report comprising the determined overall incomplete transaction rate for the item, the determined first incomplete transaction rate for the item at each of the plurality of stages of the transaction process, and the determined second incomplete transaction rate for the item with the second item added to the virtual shopping cart for each of the plurality of stages of the transaction process.

19. The non-transitory computer readable storage device of claim 18, wherein the plurality of stages comprise a shopping cart stage, a payment information stage, a shipping stage, and a confirmation stage.

20. The non-transitory computer readable storage device of claim 18, wherein the instructions further cause the one or more data processors to perform operations comprising:
transmitting a feedback e-mail in response to the determination that the transaction for the item was not completed.

21. The method of claim 1 further comprising:
receiving, by one or more data processors, data indicative of a selection of the additional item to be added to the virtual shopping cart;
storing, in the data structure, data comprising a second identifier for the additional item added to the virtual shopping cart; and
determining, using one or more data processors, a third incomplete transaction rate for the additional item for each the plurality of stages of the transaction process.

22. The method of claim 1 further comprising:
transmitting, using one or more data processors, display data to display for an informational feature about the item responsive to a predetermined period of time elapsing without a completed transaction.

23. The system of claim 13, wherein determining an incomplete transaction rate for the item comprises determining a total percentage of incomplete transactions for the item and a percentage of incomplete transactions for the item for each of a plurality of stages.

24. The method of claim 1, wherein the report comprises statistics for the item based on the data about the additional item of the virtual shopping cart.

25. The method of claim 1, wherein the report comprises other items viewed.
